(19) United States
(12) Patent Application Publication
(10) Pub. No.: US 2026/0311994 A1
(43) Pub. Date: Oct. 8, 2026

(54) HEATING SYSTEM FOR CONTROLLING TEMPERATURE OF FILM IN DRY ELECTRODE PLATE MANUFACTURING PROCESS

(71) Applicant: SAMSUNG SDI CO., LTD., Yongin-si (KR)

(72) Inventor: Jeongwook YI, Yongin-si (KR)

(21) Appl. No.: 19/563,080

(22) Filed: Mar. 11, 2026

(30) Foreign Application Priority Data
Apr. 2, 2025 (KR) 10-2025-0042969

(51) Int. Cl. H01M 4/04

(52) U.S. Cl. CPC H01M 4/0471; H01M 4/0435

(57) ABSTRACT

A dry electrode plate manufacturing device, including a hopper configured to supply a mixture powder between a plurality of calender rolls, wherein the plurality of calender rolls are configured to apply pressure to the mixture powder to manufacture a film, a laminating roll configured to press a base material and the film to manufacture a dry electrode plate, and a heating system, including one or more heat sources configured to transfer heat to one or more of the plurality of calender rolls, the mixture powder, and the film, and a controller configured to control the one or more heat sources.

### CROSS-REFERENCE TO RELATED APPLICATION

This application claims priority to and the benefit of Korean Patent Application No. 10-2025-0042969, filed on Apr. 2, 2025, the disclosure of which is incorporated herein by reference in its entirety.

### BACKGROUND

### 1. Field

The present disclosure relates to a heating system that controls the temperature of a film attached to an electrode plate for manufacturing a dry electrode plate during a process of rolling the film.

### 2. Description of the Related Art

Unlike primary batteries that cannot be charged, secondary batteries are batteries that can be charged and discharged. Low-capacity secondary batteries are used in portable small electronic devices such as smartphones, feature phones, laptop computers, digital cameras, and camcorders, whereas large-capacity secondary batteries are widely used as power sources for driving motors in hybrid vehicles, electric vehicles, and the like as well as for power storage batteries. Such a secondary battery includes an electrode assembly formed of a positive electrode and a negative electrode, a case for accommodating the electrode assembly, and electrode terminals connected to the electrode assembly.

A secondary battery manufacturing process is largely divided into an electrode plate process of forming a positive electrode plate and a negative electrode plate, an assembly process of forming a battery by inserting a separator between the positive electrode plate and the negative electrode plate, and a formation process of activating the battery so that the battery has electrical characteristics.

The electrode plate process is classified as a dry electrode plate manufacturing process (hereinafter referred to as a “dry process”) or a wet electrode plate manufacturing process (hereinafter referred to as a “wet process”). The dry process is a process in which an active material is made into a solid powder during the electrode plate process and a metal electrode plate is coated with the solid powder, whereas the wet process is a process in which an active material is mixed with an organic solvent to make liquid slurry and the electrode plate is coated with the liquid slurry.

The wet process requires investment in equipment for drying the electrode plate with high heat and recovering the solvent, but the dry process does not require such equipment and therefore has an advantage of reducing investment costs.

The dry process includes a calendering process. The calendering process is a process of rolling a mixture powder to manufacture a film to be attached to the electrode plate and uses multi-stage rolls. The calendering process has an objective of manufacturing a film with desired thickness and density by controlling a pressure between the rolls that roll the powder or film, a roll gap, a speed of each roll, and a temperature transferred to the film.

The dry process may include a powder supply process, a film manufacturing process, and a lamination process. The powder supply process is a process of supplying and uniformly distributing a pulverized mixture (powder) between calender rolls in a width direction. In addition, the film manufacturing process is a process of manufacturing an electrode plate film by utilizing the gap and pressure between the calender rolls. In the film production process, a plurality of calender rolls may be used to manufacture the film to a target thickness. In addition, the lamination process is a process of manufacturing the electrode plate by applying a pressure to the manufactured film together with a base material supplied through another roll path.

In the dry process, the film production process is a very important process. This is because manufacturing the film with the target thickness and quality through a rolling process with multiple rolls in multiple stages is an important part in improving the quality of the dry electrode plate.

The above information disclosed in this Background section is for enhancement of understanding of the background of the present disclosure, and therefore, it may contain information that does not constitute a related (or prior) art.

### SUMMARY

Embodiments include a dry electrode plate manufacturing device, including a hopper configured to supply a mixture powder between a plurality of calender rolls, wherein the plurality of calender rolls are configured to apply pressure to the mixture powder to manufacture a film, a laminating roll configured to press a base material and the film to manufacture a dry electrode plate, and a heating system, including one or more heat sources configured to transfer heat to one or more of the plurality of calender rolls, the mixture powder, and the film, and a controller configured to control the one or more heat sources.

The mixture powder may include an active material, a conductive material, and a binder.

Each of the one or more heat sources may have a target direction.

The one or more heat sources may include an external heat source outside the plurality of calender rolls.

The external heat source may be around one of a front stage, a middle stage, and a rear stage of a pressurization portion of the plurality of calender rolls.

The one or more heat sources may include a heat transfer fluid supply device configured to supply a heat transfer fluid to at least one of the plurality of calender rolls.

Each of the one or more heat sources may have a target direction, and the heating system may further include at least one blocking cover configured to block heat generated from the one or more heat sources from being transferred in a direction other than the target direction.

The one or more heat sources may include a plurality of heat sources sequential in a width direction of a specific roll of the plurality of calender rolls to face the specific roll among the plurality of calender rolls.

The one or more heat sources may include a laser heater.

The controller may control at least one of an intensity of the one or more heat sources and a temperature of the one or more heat sources.

Embodiments include a heating system applied to a dry electrode plate manufacturing device, including a plurality of calender rolls configured to apply pressure to a mixture powder to manufacture a film to be attached to an electrode plate, the heating system including one or more heat sources configured to transfer heat to one or more of the plurality of calender rolls, the mixture powder, and the film, and a controller configured to control the one or more heat sources.

The one or more heat sources may include an external heat source outside the plurality of calender rolls.

The mixture powder may include an active material, a conductive material, and a binder.

The heating system may further include a blocking cover, wherein each of the one or more heat sources has a target direction, and the blocking cover is on at least one of the one or more heat sources, the blocking cover blocking heat generated from the one or more heat sources from being transferred in a direction other than a target direction.

The one or more heat sources may include a heat transfer fluid supply device configured to supply a heat transfer fluid to at least one of the plurality of calender rolls.

The one or more heat sources may include a plurality of heat sources sequentially disposed in a width direction of a specific roll to face the specific roll among the plurality of calender rolls.

The one or more heat sources may include a laser heater.

The one or more heat sources may include a hot air blower.

The one or more heat sources may include at least one of an infrared heater, a near-infrared heater, and a far-infrared heater.

The one or more heat sources may include a positive temperature coefficient heater.

### BRIEF DESCRIPTION OF THE DRAWINGS

Features will become apparent to those of ordinary skill in the art by describing in detail exemplary embodiments with reference to the attached drawings, in which:

FIG. 1 is a diagram illustrating a configuration of a dry electrode plate manufacturing device according to an embodiment of the present disclosure;

FIG. 2 is a block diagram illustrating a configuration of a heating system according to an embodiment of the present disclosure;

FIG. 3 is an exemplary diagram illustrating a blocking cover; and

FIG. 4 is an exemplary diagram illustrating a heat source disposed at each column when a multi-row electrode plate is manufactured using the dry electrode plate manufacturing device according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

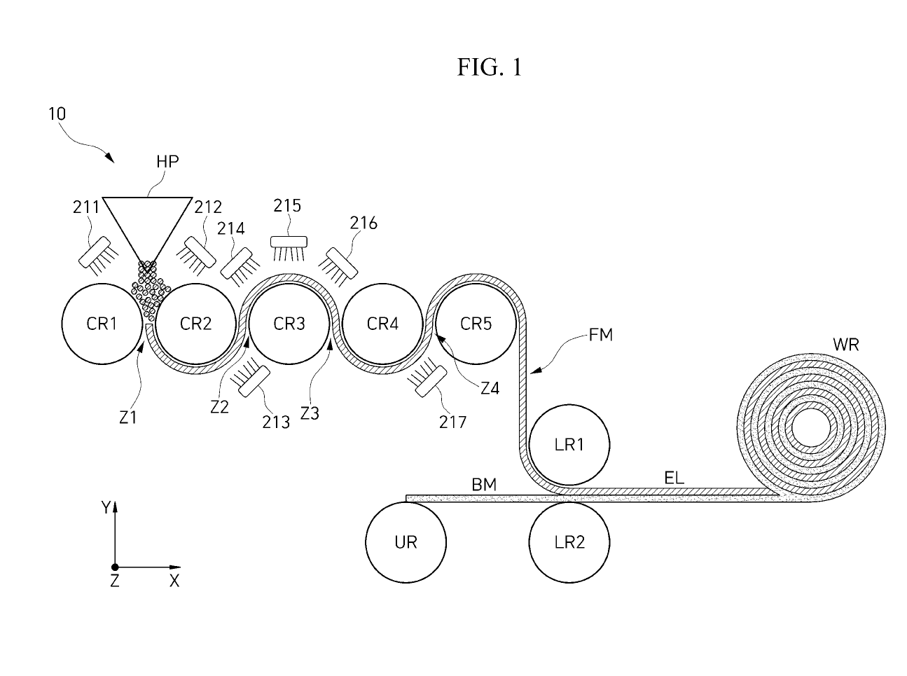

FIG. 1 is a diagram illustrating a configuration of a dry electrode plate manufacturing device according to an embodiment of the present disclosure.

A dry electrode plate manufacturing device 10 according to an embodiment of the present disclosure manufactures a dry electrode plate through a powder supply process, a film manufacturing process, and a lamination process.

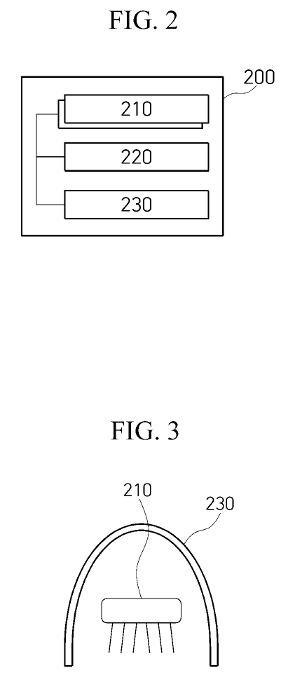

As shown in FIG. 1, the dry electrode plate manufacturing device 10 may include a hopper HP, a plurality of calender rolls CR1 to CR5, an unwinder roll UR, two laminating rolls LR1 and LR2, and a winder roll WR. In addition, the dry electrode plate manufacturing device 10 may further include a heating system 200 of FIG. 2.

The dry electrode plate manufacturing device 10 shown in FIG. 1 is according to an embodiment, and components of the dry electrode plate manufacturing device 10 according to the present disclosure may be added, changed, or omitted, as necessary. Accordingly, the number of components included in the dry electrode plate manufacturing device 10 may differ from the embodiment of FIG. 1.

In the embodiment of FIG. 1, the hopper HP supplies a mixture powder including an active material, a conductive material, and a binder between the calender rolls CR1 and CR2. The hopper HP supplies the mixture powder to be uniformly distributed between the calender rolls CR1 and CR2 in a width direction (e.g., a Z-axis direction). The plurality of calender rolls CR1 to CR5 sequentially apply pressure to the mixture powder to manufacture a film FM and supply the film FM between the laminating rolls LR1 and LR2. The pressure applied to the powder or film FM is determined by roll gaps Z1 to Z4 of the plurality of calender rolls CR1 to CR5 with a multi-stage structure. The dry electrode plate manufacturing device 10 uses the plurality of calender rolls CR1 to CR5 to manufacture the film FM having a target thickness. The unwinder roll UR supplies a base material BM between the laminating rolls LR1 and LR2. The laminating rolls LR1 and LR2 apply pressure together to the film FM supplied from the calender roll CR5 and the base material BM supplied from the unwinder roll UR to attach the film FM to the base material BM, thereby manufacturing a dry electrode plate EL. That is, the laminating rolls LR1 and LR2 press the base material BM and the film FM to manufacture the dry electrode plate EL.

The electrode plate EL manufactured by the laminating rolls LR1 and LR2 is wound by the winder roll WR.

FIG. 2 is a block diagram illustrating a configuration of a heating system according to an embodiment of the present disclosure. According to the present specification, a heating system 200 capable of precisely controlling the temperature of the film FM at each pressurizing stage using external heat sources installed at front, driving, and rear stages of pressurizing sections of the calender rolls CR1 to CR5 in the dry electrode plate manufacturing device 10 of FIG. 1 is proposed.

The heating system 200 according to an embodiment of the present disclosure includes one or more heat sources 210 and a controller 220 that controls the one or more heat sources 210. The one or more heat sources 210 include heat sources installed outside the calender rolls CR1 to CR5 (“external heat sources”) and devices supplying heat transfer fluids into the calender rolls (“heat transfer fluid supply devices”). The one or more heat sources 210 transfer heat to the calender rolls CR1 to CR5 and the mixture powder or film FM.

Among the one or more heat sources 210, the external heat source is disposed to face one of the calender rolls CR1 to CR5 and transfers heat to the roll. Specifically, the external heat source transfers heat to the powder introduced into the calender rolls CR1 to CR5 or to the film wound on the calender rolls. That is, the external heat source may have a target direction that is a direction in which heat is to be transferred. When the heating system 200 includes a plurality of external heat sources, each of the external heat sources may be disposed to face a different calender roll. That is, target directions of the plurality of heat sources 210 may be different.

In addition, the heating system 200 may further include a blocking cover 230 (see FIG. 3) that blocks the heat generated from the heat source 210 from being transferred to the rolls other than a target calender roll (or the film wound on the rolls). That is, the blocking cover 230 blocks the heat generated from the heat source 210 from being transferred in a direction other than the target direction of the heat source 210.

The heating system 200 shown in FIG. 2 is according to an embodiment, and components of the heating system 200 according to the present disclosure, other components may be added to the heating system 200 as needed, the components of FIG. 2 may be replaced with other components, the number of the components of FIG. 2 may be changed, or at least one component among the components of FIG. 2 may be omitted.

In FIG. 1, the heat source 210 includes seven of the heat sources 211 to 217. As shown in FIG. 1, the plurality of heat sources 211 to 217 may be external heat sources and disposed at various locations such as front stages 211, 212, 213, 216, and 217 of the pressurized portion, a middle traveling stage 215, and a rear stage 214. That is, the plurality of heat sources 211 to 217 are external heat sources disposed around one of the front, middle, and rear stages of the pressurized section of the calender rolls CR1 to CR5.

Examples of the heat source 210 may include a hot air blower, an induction heater, an infrared heater (IR lamp), a near-infrared heater (NIR lamp), a far-infrared heater (FIR lamp), a halogen heater, a laser heater, and a positive temperature coefficient (PTC) heater. For reference, the laser heater has an advantage of being able to precisely control the temperature of the film by adjusting an output and does not require any additional input nozzles or exhaust devices, so there is no significant restriction on installation space.

However, the types of the one or more heat sources 210 of the above-described examples may vary.

Meanwhile, the positions of the one or more heat sources 210 in the dry electrode plate manufacturing device 10 may be adjusted according to environmental and control conditions. In addition, when the one or more heat sources 210 are external heat sources, the blocking cover 230 as shown in FIG. 3 may be additionally installed to prevent heat from being lost to the air and heat from being transferred to a roll adjacent to the target calender roll.

The controller 220 controls the intensity or temperature of the heat source 210. When the heat source 210 is provided as a plurality of heat sources 210, the controller 220 may individually control an intensity or temperature of each heat source 210. That is, in FIG. 1, the intensities or temperatures of the plurality of heat sources 211 to 217 may be different. The controller 220 may include a processor, a memory, and a communication device. The memory may store commands executable by the processor, control data, and a control logic. The processor may control the heat source 210 by reading the control data and the control logic stored in the memory and executing the commands stored in the memory. The communication device transmits and receives data with an external device through wired or wireless communication.

As described above, the blocking cover 230 blocks the heat of the heat source 210 from being transferred to other locations around the target calender roll (e.g., an adjacent calender roll and air) (see FIG. 3). The heating system 200 may transfer the heat of the heat source 210 only to a target location (e.g., a specific area of the calender roll or film) through the blocking cover 230 and prevent the heat from being transferred to other portions and causing an unintended change in temperature. That is, each heat source 210 has its own target direction, and the blocking cover 230 blocks the heat generated from the heat source 210 from being transferred in a direction other than the target direction of the heat source 210. In this way, the heating system 200 may increase heat transfer efficiency.

In order to generate a difference in temperature between upper and lower portions of the film FM, the heating system 200 may simultaneously apply an external heat source and a heat transfer fluid supply device (a device according to a conventional heat transfer method using a heat transfer fluid) to the same location.

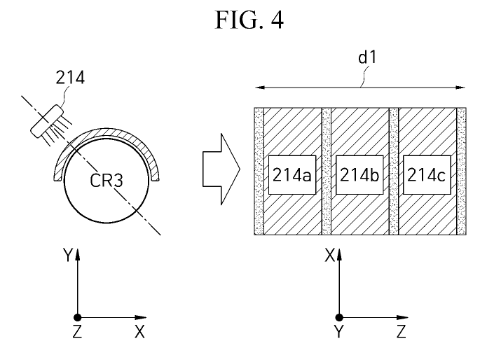

FIG. 4 is an exemplary diagram illustrating a heat source disposed at each column when a multi-row electrode plate is manufactured using the dry electrode plate manufacturing device according to an embodiment of the present disclosure.

In some cases, the dry electrode plate manufacturing device 10 manufactures a multi-row electrode plate including a plurality of columns or lines in order to increase productivity. In this case, a different production condition may be applied to the electrode plate of each row. In order for the dry electrode plate manufacturing device 10 to be able to manufacture the multi-row electrode plate, the heating system 200 may be formed such that the heat source 210 is separately disposed at each film location in a width direction d1 of the calender roll CR (see FIG. 4). When heat sources 214a, 214b, and 214c are installed separately as in the example of FIG. 4, there is an advantage in that direct heating of a roll surface may be minimized and only a film to be heated may be heated. When a multi-row electrode plate (e.g., two or three rows in the width direction) is manufactured, the heat source 210 of the heating system 200 is disposed in each row so that an effect of precisely controlling hot working temperature and lowering the heat transferred to the base material BM can be obtained.

As described above, the heat source 210 of the heating system 200 may include only the external heat source or may include both the external heat source and the heat transfer fluid supply device.

Among control factors in the film production process, temperature is a factor that has a significant impact on the quality of the electrode plate. That is, precise control of the temperature of the film is required even under various environmental conditions.

Typically, temperature control in the film production process follows an indirect heat transfer method in which a heat transfer fluid (a fluid that stores heat) flows inside a rotating roll to heat the roll, and the heat of a roll surface is transferred to the film. However, the heat transfer method cannot quickly change the temperature of the film, and since the entire roll is heated by the heat transfer fluid, it is difficult to transfer the heat only to a necessary portion of the film. In addition, the heat transfer method cannot vary the temperature in the width direction of the roll and cannot provide different temperature conditions for each position in a traveling direction of the film. In addition, since the heat transfer method is a method of circulating the heat transfer fluid heated to a constant temperature through pipes, there is also a disadvantage of low heat transfer efficiency.

According to the present disclosure, there is an effect of improving the quality of an electrode plate and maintaining consistent quality of the electrode plate by precisely controlling the temperature of an electrode plate film in a dry electrode plate manufacturing process for a secondary battery production.

Specifically, in the dry electrode plate manufacturing process, cohesion between a binder and an active material occurs due to high pressure and shear stress in a traveling direction. In this case, a temperature condition flexibly changes a binder component, which has a good effect on the cohesion and formation of the electrode plate with a target thickness. However, when the temperature is too high, the crystallization and brittleness of the binder become strong, which can cause cracks in a surface of the electrode plate or damage to the electrode plate in an extreme situation. Therefore, in the dry electrode plate manufacturing process, the precise control of a temperature condition is required, and the uniform temperature condition should be maintained.

According to the present disclosure, in the dry electrode plate manufacturing process, a separate external heat source can be used to efficiently and precisely control a temperature, and the heat source can also be locally disposed to satisfy desired production conditions. In addition, according to the present disclosure, when a traveling speed is increased to improve multi-roll productivity, the heat source can be diversified so that a problem occurring due to an increased internal temperature of the roll can be prevented.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A dry electrode plate manufacturing device, comprising:
a hopper configured to supply a mixture powder between a plurality of calender rolls, wherein the plurality of calender rolls are configured to apply pressure to the mixture powder to manufacture a film;
a laminating roll configured to press a base material and the film to manufacture a dry electrode plate; and
a heating system, including:
one or more heat sources configured to transfer heat to one or more of the plurality of calender rolls, the mixture powder, and the film; and
a controller configured to control the one or more heat sources.

2. The dry electrode plate manufacturing device as claimed in claim 1, wherein the mixture powder comprises an active material, a conductive material, and a binder.

3. The dry electrode plate manufacturing device as claimed in claim 1, wherein each of the one or more heat sources has a target direction.

4. The dry electrode plate manufacturing device as claimed in claim 1, wherein the one or more heat sources comprise an external heat source outside the plurality of calender rolls.

5. The dry electrode plate manufacturing device as claimed in claim 4, wherein the external heat source is around one of a front stage, a middle stage, and a rear stage of a pressurization portion of the plurality of calender rolls.

6. The dry electrode plate manufacturing device as claimed in claim 1, wherein the one or more heat sources comprise a heat transfer fluid supply device configured to supply a heat transfer fluid to at least one of the plurality of calender rolls.

7. The dry electrode plate manufacturing device as claimed in claim 1, wherein:
each of the one or more heat sources has a target direction, and
the heating system further comprises at least one blocking cover configured to block heat generated from the one or more heat sources from being transferred in a direction other than the target direction.

8. The dry electrode plate manufacturing device as claimed in claim 1, wherein the one or more heat sources comprise a plurality of heat sources sequential in a width direction of a specific roll to face the specific roll among the plurality of calender rolls.

9. The dry electrode plate manufacturing device as claimed in claim 1, wherein the one or more heat sources comprise a laser heater.

10. The dry electrode plate manufacturing device as claimed in claim 1, wherein the controller controls at least one of an intensity of the one or more heat sources and a temperature of the one or more heat sources.

11. A heating system applied to a dry electrode plate manufacturing device, comprising a plurality of calender rolls configured to apply pressure to a mixture powder to manufacture a film to be attached to an electrode plate, the heating system comprising:
one or more heat sources configured to transfer heat to one or more of the plurality of calender rolls, the mixture powder, and the film; and
a controller configured to control the one or more heat sources.

12. The heating system as claimed in claim 11, wherein the one or more heat sources comprise an external heat source outside the plurality of calender rolls.

13. The heating system as claimed in claim 11, wherein the mixture powder comprises an active material, a conductive material, and a binder.

14. The heating system as claimed in claim 11, further comprising a blocking cover, wherein:
each of the one or more heat sources has a target direction, and
the blocking cover is on at least one of the one or more heat sources, the blocking cover blocking heat generated from the one or more heat sources from being transferred in a direction other than the target direction.

15. The heating system as claimed in claim 11, wherein the one or more heat sources comprises a heat transfer fluid supply device configured to supply a heat transfer fluid to at least one of the plurality of calender rolls.

16. The heating system as claimed in claim 11, wherein the one or more heat sources comprises a plurality of heat sources sequentially disposed in a width direction of a specific roll to face the specific roll among the plurality of calender rolls.

17. The heating system as claimed in claim 11, wherein the one or more heat sources comprise a laser heater.

18. The heating system as claimed in claim 11, wherein the one or more heat sources comprise a hot air blower.

19. The heating system as claimed in claim 11, wherein the one or more heat sources comprise at least one of an infrared heater, a near-infrared heater, and a far-infrared heater.

20. The heating system as claimed in claim 11, wherein the one or more heat sources comprise a positive temperature coefficient heater.
